(19) United States
(12) Patent Application Publication
(10) Pub. No.: US 2024/0253942 A1
(43) Pub. Date: Aug. 1, 2024

(54) FOLDING APPARATUS

(71) Applicant: DUPLO SEIKO CORPORATION, Kinokawa-shi, Wakayama (JP)

(72) Inventors: Hidenori YOROZU, Kinokawa-shi, Wakayama (JP); Hideki OIWA, Kinokawa-shi, Wakayama (JP)

(73) Assignee: DUPLO SEIKO CORPORATION, Kinokawa-shi, Wakayama (JP)

(21) Appl. No.: 18/564,409

(22) PCT Filed: Jun. 20, 2022
(86) PCT No.: PCT/JP2022/024492

§ 371 Date: Nov. 27, 2023

(30) Foreign Application Priority Data
Jul. 8, 2021 (JP) 2021-113808

(51) Int. Cl. B65H 45/16; B65H 5/06

(52) U.S. Cl. CPC B65H 45/16; B65H 5/06

(57) ABSTRACT

An object of the present disclosure is to provide a folding apparatus capable of properly executing a folding process with reducing obstruction to its operation for folding by rollers conveying a sheet when the sheet is folded keeping the sheet being held on a conveying path. The folding apparatus includes a conveying device having rollers to hold and convey a sheet, and a folding device folding the sheet conveyed by the conveying device, the folding device including a holding part that holds the sheet on a conveying path, and an approximating part that approximates a folding piece of the sheet to a position opposite a held piece of the sheet held by the holding part, the conveying device including a retreating part that retreats the rollers from the conveying path when the sheet is folded by the folding device.

### TECHNICAL FIELD

The present invention relates to a folding apparatus.

### BACKGROUND ART

A folding apparatus has conventionally been known that folds a sheet conveyed thereto. Patent Document 1 below discloses a folding apparatus capable of suppressing a dislocation of a folding position of a sheet to be folded.

### PATENT DOCUMENTS

Patent Document 1: JP2015199561A

### SUMMARY OF THE INVENTION

The device described in Patent Document 1 above folds the sheet while conveying the sheet by folding rollers. In this case, the folding rollers can continuously execute a folding process while holding and conveying the sheet at all times, and the work efficiency is therefore improved. The case where the sheet can be folded using the above folding rollers is the case where the sheet has a relatively small thickness such as that of a copying paper sheet or a letter. On the other hand, in the case where the sheet has a thickness that is larger than a predetermined value, it is difficult to execute the folding process using the folding rollers for such a sheet as, for example, a corrugated cardboard for manufacturing a box to hold bottles of an alcoholic drink, or a cardboard for a box to hold name cards or for a holder with a pocket capable of sandwiching and holding therein a catalog, a flyer, or the like.

In the case where the sheet has a thickness larger than the predetermined value, a method can be considered according to which the sheet is held on a conveying path and the sheet is folded by moving a portion desired to be folded of the sheet toward a position opposite the sheet held on the conveying path. Risk that folding the sheet properly becomes difficult is however present in the case where the sheet itself is held by the conveying rollers when the portion desired to be folded of the sheet is approximated to the portion held on the conveying path.

An object of the present invention is to provide a folding apparatus capable of properly executing a folding process with reducing obstruction to its operation for folding by rollers conveying a sheet when the sheet is folded keeping the sheet being held on a conveying path.

In order to achieve the object, a folding apparatus according to the present invention includes: a conveying device including a roller that holds and conveys a sheet; and a folding device that folds the sheet conveyed by the conveying device. The folding device includes: a holding part that holds the sheet on a conveying path; and an approximating part that approximates a folding piece of the sheet to a position opposite a held piece of the sheet held by the holding part. The conveying device includes a retreating part that retreats the roller from the conveying path when the sheet is folded by the folding device.

In the folding apparatus, the approximating part may include a rotating part that rotates the folding piece toward the held piece centering a crease formed on the sheet as a rotation center.

In the folding apparatus, the sheet may have a longitudinal crease along a conveyance direction of the conveying device and a transverse crease along a width direction perpendicular to the conveyance direction, and the folding device may fold the sheet at the longitudinal crease or at the transverse crease.

In the folding apparatus, the retreating part may include a moving part that moves an axis rotatably supporting the roller toward an outside of the conveying path.

In the folding apparatus, the moving part may include a swinging part that swings the axis with a swinging shaft as a pivoting center.

In the folding apparatus, the swinging shaft may extend along the conveyance direction.

In the folding apparatus, the retreating part may move the rollers from a conveyance position at which a rotating shaft of the rollers is along the width direction perpendicular to the conveyance direction of the conveying device to a retreat position at which the rotating shaft is in a direction that intersects with the width direction.

In the folding apparatus, the rotating shaft may be along an up-down direction at the retreat position.

According to the present invention, the folding apparatus includes the conveying device that includes a roller to hold the sheet therebetween to convey the sheet, and the folding device that folds the sheet conveyed by the conveying device. The folding device includes the holding part that holds the sheet on the conveying path, and the approximating part that approximates the folding piece of the sheet to the position opposite the held piece of the sheet held by the holding part. The conveying device includes the retreating part that retreats the roller from the conveying path when the sheet is folded by the folding device. The folding piece can therefore be properly approximated to the held piece that is held by the holding part.

In the case where the approximating part includes a rotating part that rotates the folding piece toward the held piece centering the crease formed on the sheet as the rotation center, the sheet can easily be folded.

In the case where the folding device folds the sheet along the longitudinal crease along the conveyance direction of the conveying device or the transverse crease along the width direction perpendicular to the conveyance direction thereof, that is disposed on the sheet, the sheet can more easily be folded.

In the case where the retreating part includes the moving part that moves the axis rotatably supporting the roller, toward the outside of the conveying path, the roller can easily be moved toward the outside of the conveying path.

In the case where the moving part includes the swinging part that swings the axis with the swinging shaft as the pivoting center, the roller can easily be moved from the conveying path keeping the roller being supported by the axis.

In the case where the swinging shaft extends along the conveyance direction, the rollers can be moved in the direction to be spaced from the conveying path by swinging the axis with the swinging shaft as the pivoting center.

In the case where the retreating part moves the rollers from the conveyance position at which the rotating shaft of the roller is along the width direction perpendicular to the conveyance direction of the conveying device to the retreat position at which the rotating shaft is in the direction that intersects with the width direction, the roller extending in the width direction at the conveyance position can easily be moved to the retreat position when the folding piece is approximated to the held piece keeping the held piece being held by the holding part.

In the case where the rotating shaft is along the up-down direction at the retreat position, the roller can more easily be retreated.

### BRIEF DESCRIPTION OF DRAWINGS

FIG. 1 is a schematic longitudinal cross-sectional view of a folding apparatus according to one embodiment of the present invention.

FIG. 2 is a plan view of the folding apparatus.

FIG. 3 is a perspective view of rollers and a support unit of the folding apparatus.

FIG. 4 is a plan view of the rollers and the support unit.

FIG. 5 is a front view of the rollers and the support unit.

FIG. 6 is a longitudinal cross-sectional view of the rollers and the support unit.

FIG. 7 is a use mode diagram of the rollers and the support unit.

FIG. 8 is a plan view of a sheet to be processed by the folding apparatus.

FIG. 9 is a diagram showing steps of folding the sheet.

FIG. 10 is a use mode diagram of the folding apparatus.

FIG. 11 is a use mode diagram of the folding apparatus.

FIG. 12 is a longitudinal cross-sectional view of a support unit according to another embodiment of the present invention.

### DETAILED DESCRIPTION

### First Embodiment

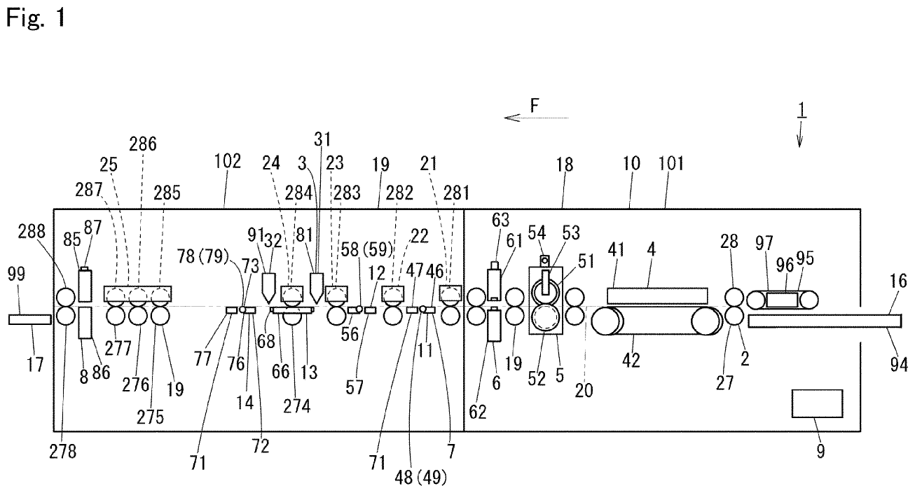

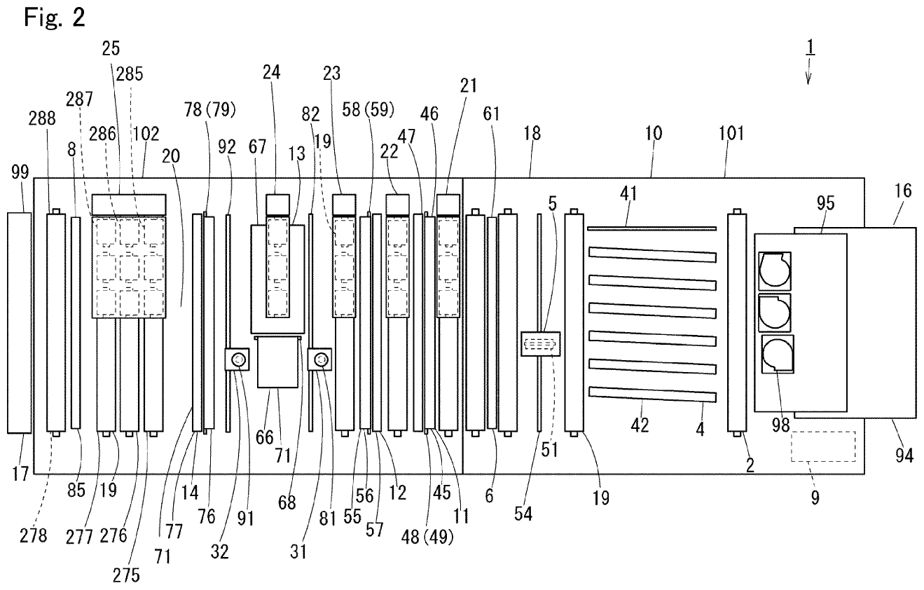

FIG. 1 is a longitudinal cross-sectional view showing a schematic configuration of a processing device 1 according to one embodiment of the present invention, and FIG. 2 is a plan view of the processing device. The processing device 1 includes a first apparatus 101 and a second apparatus 102. The first apparatus 101 includes a feeding device 16, an oblique correcting device 4, a longitudinal crease device 5, and a transverse crease device 6. The second apparatus 102 includes folding devices 7, paste applying devices 3, a pressing device 8, and a discharging device 17.

The processing device 1 includes a controller 9 that controls the operation of the overall device, in a device main body 10. A conveying path 20 is formed from the feeding device 16 to the paper discharging device 17 by a conveying device 2 that includes plural rollers 19 that holds a sheet S therebetween to convey the sheet S.

The feeding device 16 includes a feeding tray 94 and a suctioning and conveying device 95. The feeding tray 94 has the sheet S loaded thereon. The feeding tray 94 is ascended and descended by an ascending and descending device not shown. The suctioning and conveying device 95 includes a suctioning box 96 and a conveying belt 97. The suctioning box 96 is connected to an air blower 98 shown in FIG. 2. A negative pressure is generated in the suctioning box 96 by the driving of the air blower 98 and the sheet S at the top on the feeding tray 94 is thereby suctioned on the lower face of the conveying belt 97.

The oblique correcting device 4 includes a guide 41 and an oblique belt 42. A side end of the sheet S contacts the guide 41. The sheet S is conveyed toward the guide 41 by the running of the oblique belt 42, and is conveyed to the downstream side keeping one side end edge thereof contacting the guide 41.

The longitudinal crease device 5 forms a crease C along a conveyance direction F on the sheet S. The longitudinal crease device 5 includes an upper member 51, a lower member 52, a spacing part 53, and a transverse moving part 54. The upper member 51 is disposed above the conveying path 20. The upper member 51 is formed in a discoidal shape and has a concave groove formed on the circumferential face thereof. The lower member 52 is disposed under the conveying path 20 at the position facing the upper member 51. The lower member 52 is formed in a discoidal shape whose radius is substantially equal to that of the upper member 51 and has a convex part that engages with the concave groove, formed on the circumferential face thereof. The spacing part 53 causes the upper member 51 to be spaced from the lower member 52. The transverse moving part 54 moves the upper member 51 and the lower member 52 together as one in a width direction W perpendicular to the conveyance direction F.

The transverse crease device 6 forms a crease C along the width direction W on the sheet S. The transverse crease device 6 includes a concave member 61, a convex member 62, and an ascending and descending device 63. The concave member 61 is disposed above the conveying path 20 and is ascended or descended by the ascending and descending device 63. The convex member 62 is disposed under the conveying path 20 facing the concave member 61.

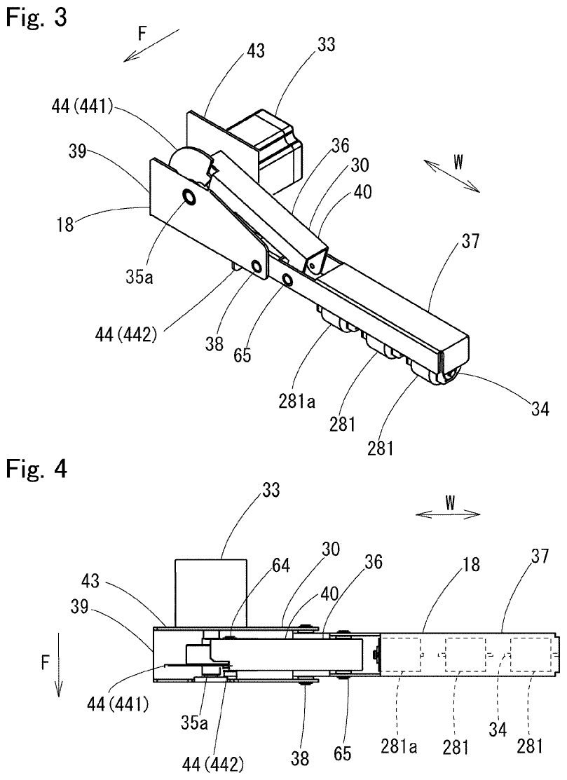

The folding devices 7 each fold the sheet S conveyed by the conveying device 2. The folding devices 7 each fold the sheet S along a longitudinal crease Cf along the conveyance direction of the conveying device 2 or a transverse crease CW along the width direction W perpendicular to the conveyance direction F, that is disposed on the sheet S (see FIG. 3).

The folding devices 7 each include a holding part 71 and an approximating part 72. The holding part 71 holds the sheet S on the conveying path 20. The approximating part 72 approximates a folding piece of the sheet S to the position opposite a held piece of the sheet S held by the holding part 71. The approximating part 72 includes a rotating part 73. The rotating part 73 rotates the folding piece toward the held piece centering the crease C formed on the sheet S as the rotation center. The folding devices 7 include a first to a fourth folding devices 11 to 14.

The first folding device 11 is disposed on the most upstream side, of the four folding devices 7. The first folding device 11 folds a rear paste margin E disposed in a rear end portion of the sheet S along a rear crease C2 formed along the width direction W perpendicular to the conveyance direction F of the conveying device 2 (see FIG. 3). The first folding device 11 includes a first approximating part 46 and a first holding part 47.

The first approximating part 46 includes a first rotating member 45 and a first rotating part 48. The first rotating part 48 rotates the first rotating member 45 toward the first holding part 47 on the downstream side with a first rotating shaft 49 as the pivoting center. The first rotating part 48 thereby rotates the rear paste margin E that is the folding piece toward a main body B that is the held piece centering the rear crease C2 formed on the sheet S as the rotation center.

The second folding device 12 is disposed on the downstream side of the first folding device 11. The second folding device 12 folds a front end portion of the sheet S along the width direction W. The second folding device 12 includes a second approximating part 56 and a second holding part 57. The second approximating part 72 includes a second rotating member 55 and a second rotating part 58. The second rotating part 58 rotates the second rotating member 55 toward the second holding part 57 on the upstream side thereof with a second rotating shaft 59 as the pivoting center. The second rotating part 58 thereby rotates a front paste margin D as the folding piece toward the main body B as the held piece centering a front transverse crease C1 formed on the sheet S as the rotation center.

The third folding device 13 is disposed on the downstream side of the second folding device 12 and between the two paste applying devices 3. The third folding device 13 folds the sheet S along a longitudinal crease Cf along the conveyance direction F of the conveying device 2, disposed on the sheet S. The third folding device 13 includes a third approximating part 66, a third holding part 67, and a moving part not shown. The third approximating part 66 includes a third rotating part 68. As shown in FIG. 2, the third rotating part 68 and the third holding part 67 are disposed side by side in the width direction W. The third rotating part 68 rotates a third rotating member 65 toward the third holding part 67 disposed adjacent thereto in the width direction W with a third rotating shaft 69 as the pivoting center. The moving part moves the crease third approximating part 66 and the third holding part 67 together as one in the width direction W matching with the position of the crease C. The folding piece is thereby rotated toward the held piece centering the crease C along the conveyance direction F as the rotation center, to be folded.

The fourth folding device 14 is disposed on the downstream side of 4. The fourth folding device 14 folds the sheet S along a central crease C5 along the width direction W disposed at the center of the sheet S in the conveyance direction F. The fourth folding device 14 includes a fourth approximating part 76 and a fourth holding part 77. The fourth approximating part 76 includes a fourth rotating part 78. The fourth rotating part 78 rotates a fourth rotating member 75 toward the fourth holding part 77 on the upstream side thereof with a fourth rotating shaft 79 as the pivoting center.

The paste applying devices 3 include a first and a second paste applying devices 31 and 32. The first paste applying device 31 is disposed between the second folding device 12 and the third folding device 13. The first paste applying device 31 applies paste along the width direction W onto the sheet S. The first paste applying device 31 includes a first nozzle 81, a first paste feeding device not shown, and a first paste moving part 82. The first nozzle 81 sprays the paste G from the first paste feeding device, toward the sheet S to apply the paste G onto the sheet S. The first paste feeding device feeds the paste G to the first nozzle 81. The first paste moving part 82 moves the first nozzle 81 in the width direction W.

The second paste applying device 32 is disposed between the third folding device 13 and the fourth folding device 14. The second paste applying device 32 applies the paste along the width direction W onto the sheet S. The second paste applying device 32 includes a second nozzle 91, a second paste feeding device not shown, and a second paste moving part 92. The second nozzle 91 sprays the paste G from the second paste feeding device, toward the sheet S to apply the paste G onto the sheet S. The second paste feeding device feeds the paste G to the second nozzle 91. The second paste moving part 92 moves the second nozzle 91 in the width direction W.

The pressing device 8 presses the crease C of the sheet S. The pressing device 8 includes a pair of an upper and a lower pressing members 85 and 86, and an ascending and descending device 87. The pair of pressing members 85 and 86 are disposed facing each other in the up-down direction through the conveying path 20. The ascending and descending device 86 ascends or descends the pressing member 85 disposed above the conveying path 20 toward the other pressing member 86 that faces the pressing member 85.

The discharging device 17 has the processed sheet S loaded thereon. The discharging device 17 includes a discharge tray 99.

The controller 9 includes a CPU that is connected to an operational panel not shown. The operational panel functions as a setting part that sets processing information for the sheet S. The setting part is configured to be capable of setting the type, the thickness, the hardness, and the like of the sheet S by inputting these manually thereinto by a user. The setting part can also fetch, from a storing part, and set the type, the thickness, the hardness, and the like of the sheet S together with the processing content for the sheet S by inputting thereinto or selecting a number or the like by the user. The operational panel also functions as a displaying part that displays thereon various types of information.

The conveying device 2 is configured to hold the sheet S therebetween and convey the sheet S from the feeding device 16 toward the paper discharging device 17. Of the plural rollers 19, lower rollers 27 located under the conveying path 20 are coupled with a conveyance driving part not shown. The length in the width direction W of all the other lower rollers 27 except a lower roller 273 disposed in the third folding device 13 is set to be longer than the length in the width direction W of the conveying path 20 on which the sheet S is conveyed. The lower roller 273 disposed in the third folding device 13 is set to be shorter than the length in the width direction W of the conveying path 20 and to be about a half thereof.

Rollers 28 disposed above the conveying path 20 are rotated being driven by the rotations of the lower rollers 27 that face the rollers 28. All the rollers 28 on the upper side of the conveying path 20 of the first apparatus 101 and a roller 288 on the upper side of the conveying path 20, disposed most downstream in the second apparatus 102 are each formed to have a length in the width direction W that is longer than the length in the width direction W of the conveying path 20 on which the sheet S is conveyed. These rollers 28 each have a length in the width direction W that is substantially equal to that of the lower roller 27 that the roller 28 faces.

In contrast, rollers 281 to 287 disposed above the conveying path 20 on the side more upstream than the pressing device 8 of the second apparatus 102 are disposed in a range shorter than the length in the width direction W of the conveying path 20. FIG. 2 shows the case where the rollers 281 to 287 on the upper side on the side more upstream than the pressing device 8 of the second apparatus 102 are disposed each having a length that is about a half of that in the width direction W of the conveying path 20, at positions on the left side in FIG. 2.

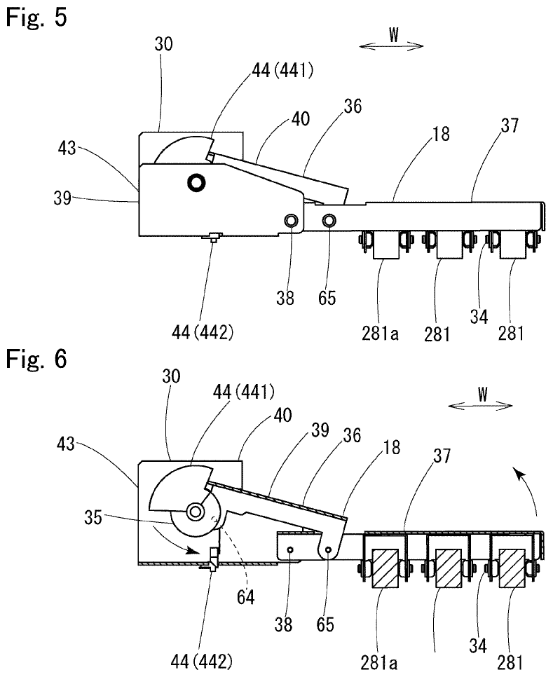

FIG. 3 is a perspective view of the roller 281 on the upper side of the conveying path 20 on the most upstream side in the second apparatus 102 and a support unit 18 for the roller 281. FIG. 4 is a plan view of the roller 281 and the support unit 18. FIG. 5 is a diagram of the roller 281 and the support unit 18 taken when seen from a front view. FIG. 6 is a longitudinal cross-sectional view of the roller 281 and the support unit 18.

The roller 281 positioned most upstream in the second apparatus 102 is divided into plural pieces in the width direction W. The support unit 18 includes an axis 37 and a retreating part 39. The axis 37 rotatably supports all the divided plural pieces of the roller 281. The axis 37 is formed to have a laterally elongated cuboidal shape having an open bottom portion, and holds therein the roller 281. The roller 281 is configured to be capable of retreating from the conveying path 20 caused by the retreating part 39, being supported by the axis 37. The retreating part 39 causes the roller 26 to retreat from the conveying path 20 when the sheet S is folded by the folding device 7.

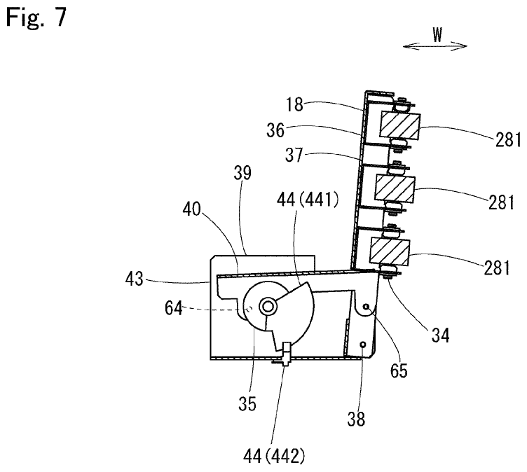

The retreating part 39 moves the roller 28 from a conveyance position at which a rotating shaft 34 of the roller 281 is along the width direction W perpendicular to the conveyance direction F of the conveying device 2, to a retreat position at which the rotating shaft 34 is in the direction that intersects with the width direction W. In this embodiment, the case is described where the rotating shaft 34 is along the up-down direction at the retreat position as shown in FIG. 7.

The retreating part 39 includes a moving part 30. The moving part 30 moves the axis 37 that rotatably supports the roller 281, toward the outside of the conveying path 20. The moving part 30 includes a swinging part 40. The swinging part 40 swings the axis 37 with a swinging shaft 38 as the pivoting center. The swinging shaft 38 extends along the conveyance direction F. The swinging part 40 includes a driving part 33, a support bed 43, a rotating body 35, a link 36, and a detector 44. The detector 44 includes a light shielding plate 441 and an optical sensor 442.

The driving part 33, the rotating body 35, and the swinging shaft 38 are supported by the support bed 43 that is fixed to the device main body 10. The rotating body 35 is rotated by being driven by the driving part 33. One end portion of the link 36 is coupled with a disc face of the rotating body 35 by a pin 64. The other end portion of the link 36 is coupled with a point between the swinging shaft 38 of the axis 37 and a roller 281a that is positioned on the leftmost side in FIG. 5, by a pin 65.

The light shielding plate 441 is fixed to a rotating shaft 35a of the rotating body 35. The light shielding plate 441 is detected by the sensor 442 that is disposed under the rotating body 35 to detect whether the roller 281 is positioned at the retreat position or the conveyance position.

When the sheet S is conveyed, the roller 281 is positioned at the conveyance position. When the sheet S is folded, the roller 281 is moved to the retreat position. When the roller 281 is moved to the retreat position, the driving part 33 is driven and the rotating body 35 is thereby rotated counterclockwise in FIG. 6 by a predetermined amount. The rotation of the rotating body 35 causes the link 36 to move leftward in FIG. 6 and causes a coupling part to the link 36 by the pin 65 of the axis 37 to move leftward in FIG. 6. The axis 37 is thereby swung with the swinging shaft 38 as the pivoting center.

As shown in FIG. 7, the axis 37 moves the roller 281 from the horizontal attitude thereof to an attitude parallel to the up-down direction, supporting the roller 281. The disposition direction of the roller 281 is varied by substantially 90 degrees. The conveying path 20 is opened by the move of the roller 281 from the conveyance position to the retreat position.

The other rollers 282 to 287 on the upper side of the conveying path 20 on the side more upstream of the pressing device 8 of the second apparatus 102 also each have a substantially same configuration as that of the roller 281 and the support unit 18 therefor disposed most upstream in the second apparatus 102 shown in FIGS. 5 to 8. Rollers 285 to 287 on the upper side of the conveying path 20 respectively facing three rollers 275 to 277 on the lower side of the conveying path 20 that are disposed adjacent to the pressing device 8, on the upstream side thereof are moved together as one from the conveyance position to the retreat position by the one retreating part 39.

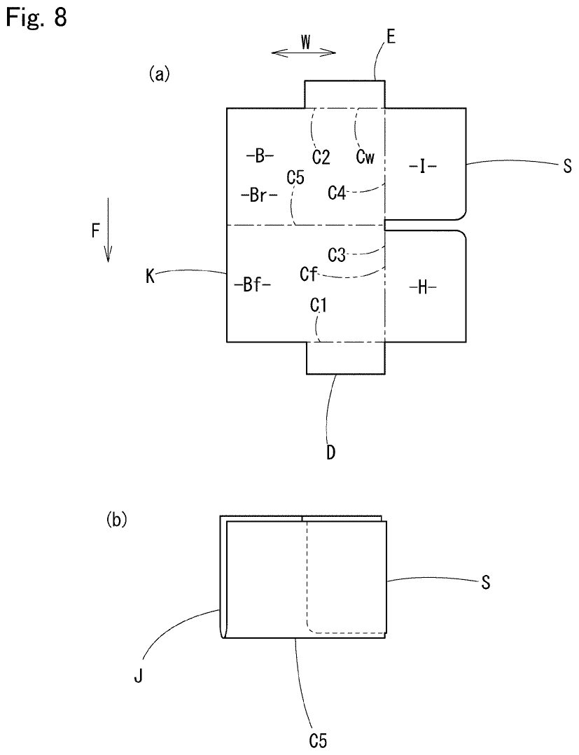

An operation of the processing device 1 will next be described. FIG. 8 is a plan view of the sheet S to be processed by the processing device 1 according to this embodiment. The sheet S is cut out into a predetermined shape in advance by a punching die. When the sheet S is folded, the sheet S includes a held piece that is held on the conveying path 20 by the holding part 71 of the folding device 7, and a folding piece to be folded to the position opposite the held piece. The held piece includes the main body B. The folding piece includes a front paste margin D, the rear paste margin E, a front folding piece H, and a rear folding piece I. When the sheet S is folded in half along a central crease C, a portion Br on the upstream side of the main body B constitutes the held piece, and a portion Bf on the downstream side of the main body B constitutes the folding piece.

The sheet S has the longitudinal crease Cf along the conveyance direction F of the conveying device 2 or the transverse crease CW along the width direction W perpendicular to the conveyance direction F, disposed thereon. As to the sheet S shown in FIG. 8, the longitudinal crease Cf includes a front longitudinal crease C3 and a rear longitudinal crease C4. The transverse crease CW includes a front transverse crease C1 and a rear transverse crease C2.

The paste G is applied to the front paste margin D and the rear paste margin E. The front paste margin D, the rear paste margin E, the front folding piece H, and the rear folding piece I are folded toward the main body B respectively along the front transverse crease C1, the rear transverse crease C2, the front longitudinal crease C3, and the rear longitudinal crease C4. For the sheet S, a processed object J shown in FIG. 8(b) is formed by folding the main body B in half along the central crease C5.

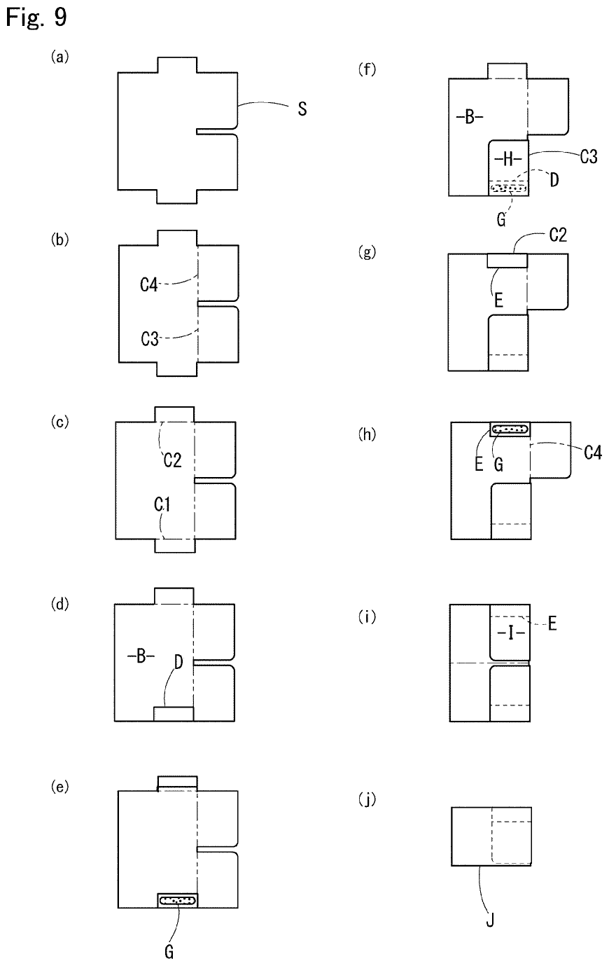

When the sheet S is processed using the processing device 1, FIG. 8(a), the sheet S is loaded on the feeding tray 94. FIG. 9 shows the steps executed when the sheet S is sequentially folded. The sheet S at the top on the feeding tray 94 is fed to the oblique correcting device 4 on the downstream side by the suctioning and conveying device 95.

In the oblique correcting device 4, the sheet S is conveyed by the running of the oblique belt 42, causing a side edge K shown on the right side in FIG. 8 to follow the guide 41 for any oblique travelling to be corrected. When the sheet S arrives at the longitudinal crease device 5, as shown by a dashed-two dotted line in FIG. 9(b), the front longitudinal crease C3 and the rear longitudinal crease C4 are formed along the conveyance direction F.

The sheet S is thereafter conveyed to the transverse crease device 6. At the timing at which the front transverse crease C1 of the sheet S is positioned between the concave member 61 and the convex member 62, the controller 9 stops the conveyance of the sheet S by the conveying device 2. The controller 9 drives the ascending and descending device 63 to engage the concave member 61 with the convex member 62 through the sheet S, to form the front transverse crease C1. The rear transverse crease C2 is also formed in the same manner as that for the front transverse crease C1. The front transverse crease C1 and the rear transverse crease C2 shown in FIG. 9(c) are thereby formed.

The head portion of the sheet S thereafter passes through the first folding device 11 and arrives at the second folding device 12. When the front transverse crease C1 arrives above the second rotating shaft 59 of the second folding device 12, the controller 9 stops the conveyance of the sheet S.

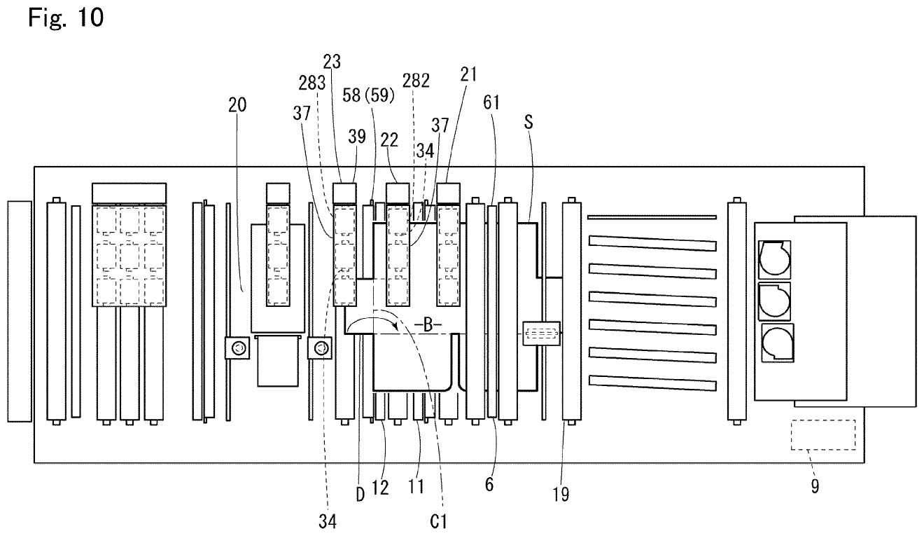

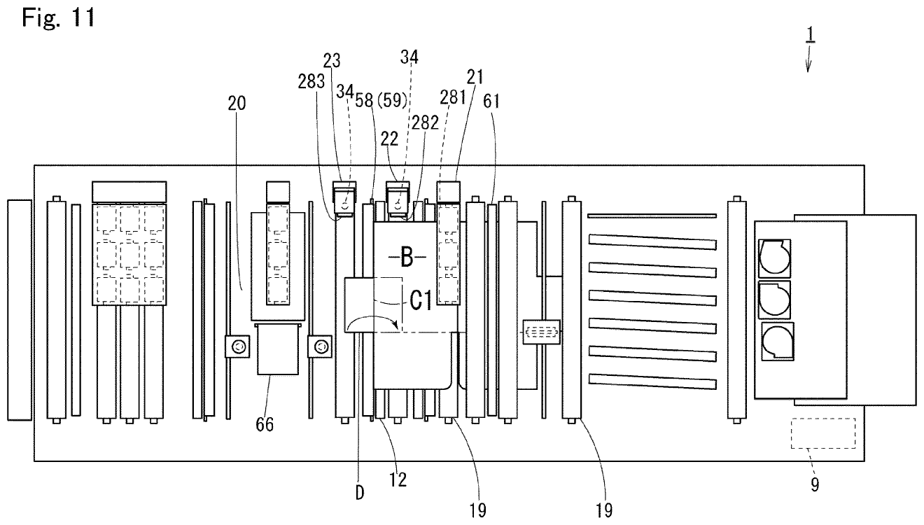

FIG. 10 is a plan view showing the state where the controller 9 stops the conveyance of the conveying device 2 to fold the sheet S along the front transverse crease C1. In FIG. 10, the sheet S is held by the rollers 19. The front transverse crease C1 is positioned above the second rotating shaft 59 of the second folding device 12. The rollers 282 disposed adjacent to the second folding device 12 on the upstream side thereof and the rollers 283 disposed adjacent thereto on the downstream side thereof respectively hold therebetween the main body B and the front paste margin D of the sheet S. Even through folding back the front paste margin D toward the main body B present on the upstream side thereof is tried along the front transverse crease C1 to move the front paste margin D to the position indicated by a dashed-dotted line as indicated by an arrow in FIG. 10, the rollers 282 and 283 are all present on the move route of the front paste margin D and the front paste margin D therefore cannot be folded toward the main body B in this state.

The controller 9 therefore causes the rollers 282 and 283 disposed adjacent to the second folding device 12 on the upstream side and the downstream side thereof to retreat from the conveying path 20 using the retreating part 39. The controller 9 drives the driving part 33 of each of the second and the third retreating parts 22 and 23. The rotating body 35 of the retreating part 39 is thereby rotated by a predetermined amount. The link 36 acts on the axis 37 to swing the axis 37 with the swinging shaft 38 as the pivoting center.

At the conveyance position, the axis 37 extends in the width direction W and the rollers 282 and 283 whose rotating shafts 34 are present in the horizontal direction are pulled up such that the rotating shafts 34 are in the direction along the up-down direction as shown in FIG. 7.

The rollers 283 and 282 are moved from the state where the rollers 283 and 282 respectively hold the front paste margin D and the main body B at the conveyance position, to the retreat position present lateral to the conveying path 20. The sheet S is thereby released from the state where the sheet S is held by the roller s 282 and 283 on the conveying path 20 as shown in FIG. 11. The lower face of the sheet S is supported by the roller 27 and the second holding part 57 on the lower side of the conveying path 20 while the upper face of the sheet S is exposed in the vicinity of the second folding device 12.

The controller 9 drives the second rotating part 58 to swing the second approximating part 56 with the second rotating shaft 59 as the pivoting center, to approximate the second approximating part 56 to the second holding part 57. The front paste margin D is rotated centering the front transverse crease C1 as the rotation center on the conveying path 20 to be folded back toward the upstream side drawing an arc to be moved to the position opposite the main body B. Because the rollers 282 and 283 are all moved to the retreat position, the event is avoided that the folding operation is obstructed by the presence of the rollers 282 and 283 in the move route of the front paste margin D when the front paste margin D is folded on the conveying path 20.

The sheet S is folded along the front transverse crease C1 and the front paste margin D is thereby caused to overlap on the main body B, and the sheet S thereby establishes the state shown in FIG. 9(d). After folding the front paste margin D, the controller 9 drives the second rotating part 58 to return the second approximating part 56 to the original position thereof. The controller 9 also drives the driving part 33 to move the rollers 282 and 283 from the retreat position to the conveyance position. The controller 9 drives the conveying device 2. The sheet S is conveyed to the downstream side with the front transverse crease C1 at the head thereof.

The front transverse crease C1 passes through the first paste applying device 31 and the third folding device 13. When the front paste margin D arrives at the second paste applying device 32, the controller 9 stops the conveying device 2. The controller 9 causes the second nozzle 91 of the second paste applying device 32 to spray the paste G, therefrom to apply the paste G on the upper face of the front paste margin D that is folded back.

Keeping the sheet S at the position at which the paste is applied to the front paste margin D, the controller 9 causes the front folding piece H to be folded back toward the main body B along the front longitudinal crease C3, without moving the sheet S. At this time, the controller 9 first moves the roller 284 on the upper side of the conveying path 20 disposed in the third folding device 13, from the conveyance position to the retreat position. Such an event does not thereby occur as that, when the front folding piece H is folded toward the main body B, the folding operation is obstructed due to the fact that the roller 284 is positioned on the main body B.

The controller 9 drives the third rotating part 68. The third approximating part 66 is swung with the third rotating shaft 69 as the pivoting center to arrive at the position facing the third holding part 67.

As shown in FIG. 9(f), the sheet S is folded along the front longitudinal crease C3. The front folding piece H is caused to overlap above the main body B. Because, at this time, the front paste margin D is already folded on the main body B to each face each other in the head portion of the sheet S and the paste G is applied onto the upper face of the front paste margin D, the upper face of the front paste margin D and the lower face of the front end portion of the front folding piece H are bonded to each other.

The controller 9 thereafter drives the retreating part 39 that retreats the roller 284 disposed in the third folding device 13. The roller 284 is moved from the retreat position to the conveyance position. The roller 284 holds the main body B and the front folding piece H cooperating with the roller 274 on the lower side of the conveying path 20, therebetween. When the controller 9 drives the conveying device 2, the sheet S is conveyed to the downstream side by the roller 284 and the roller 274 that faces the roller 284.

When the rear transverse crease C2 in the rear portion of the sheet S thereafter arrives at the disposition position of the second rotating shaft 49 of the first folding device 11, the controller 9 stops the conveying device 2. The roller 281 adjacent to the first folding device 11 on the upstream side thereof and the roller 282 adjacent thereto on the downstream side thereof are moved from the conveyance position to the retreat position by driving the retreating part 39 of each of the rollers 281 and 282. The sheet S held by the rollers 281 and 282 is thereby released.

The controller 9 drives the first rotating part 48. The sheet S is folded along the rear transverse crease C2 and the rear paste margin E is positioned above the main body B. The sheet S thereby establishes the state shown in FIG. 9(g).

The controller 9 returns the rollers 281 and 282 to the conveyance position using the retreating part 39. The controller 9 drives the conveying device 2. When the rear paste margin E arrives at the first paste applying device 31, the controller 9 stops the conveying device 2. When the controller 9 causes the first nozzle 81 to spray the paste G therefrom, the paste G is applied onto the upper face of the rear paste margin E as shown in FIG. 9(h).

Keeping the sheet S at the position at which the paste is applied to the rear paste margin E, the controller 9 causes the rear folding piece I to be folded back toward the main body B along the rear longitudinal crease C4, without moving the sheet S. At this time, the controller 9 drives the retreating part 39 that retreats the roller 284 disposed in the third folding device 13. The roller 284 is caused to be moved from the conveyance position to the retreat position.

The controller 9 drives the third rotating part 68 to swing the third approximating part 66 with the third rotating shaft 69 as the pivoting center to position the third approximating part 66 at the position facing the third holding part 67. The sheet S is thereby folded along the rear longitudinal crease C4. The rear paste margin E and the rear end portion of the rear folding piece I are bonded to each other by the paste G on the upper face of the rear paste margin E positioned between the main body B and the rear folding piece I.

The controller 9 returns the roller 284 to the conveyance position using the retreating part 39. The controller 9 drives the conveying device 2. When the central crease C5 arrives at the fourth folding device 14 the controller 9 stops the conveying device 2. The controller 9 causes the three rollers 285 to 287 adjacent to the fourth folding device 14 on the downstream side thereof to move together as one from the conveyance position to the retreat position using the retreating part 39.

The controller 9 causes the fourth approximating part 76 to swing to approximate the downstream side portion Bf of the main body B to the upstream side portion Br of the main body B as the held piece held by the fourth holding part 77 to fold the sheet S along the central crease C5. The controller 9 thereafter drives the fourth rotating part 78 to return the fourth rotating member 75 to the original position thereof on the conveying path 20. The controller 9 returns the rollers 285 to 287 positioned at the retreat position together as one to their conveyance position using the retreating part 39. The folded sheet S is conveyed by the conveying device 2 with the central crease C5 at the head thereof.

When the head portion of the sheet S arrives at the pressing device 8, the controller 9 stops the conveying device 2. The controller 9 drives the ascending and descending device 87 to descend the pressing member 85 on the upper side of the conveying path 20 toward the pressing member 86 on the lower side thereof. The central crease C5 is pressed by the pair of pressing members 85 and 86 for the sheet S to be firmly folded.

The controller 2 resumes the driving of the conveying device 2, and stops the conveyance at the time point at which the rear end portion of the sheet S arrives at the pressing device 8. The controller 2 presses the front transverse crease C1 and the rear transverse crease C that are overlapped on each other in the up-down direction using the pair of pressing members 85 and 86. The front transverse crease C1 and the rear transverse crease C2 are more firmly folded, and the front past margin D and the front folding piece H, and the rear paste margin E and the rear folding piece I are strongly bonded to each other by the applied paste G. The processed object J acquired by the processing is discharged on the discharge tray 99.

From the above, because the folding apparatus 1 according to this first embodiment includes the conveying device 2 that includes the rollers 19 to hold the sheet S to convey the sheet S and a folding device 7 that folds the sheet S conveyed by the conveying device 2, the folding device 7 includes the holding part 71 that holds the sheet S on the conveying path 20 and the approximating part 73 that approximates the folding piece of the sheet S to the position opposite the held piece of the sheet S held by the holding part 72, and the conveying device 2 includes the retreating part 39 that retreats the rollers S from the conveying path 20 when the sheet S is folded by the folding device 7, the folding piece can be approximated to the position opposite the held piece keeping the held piece of the sheet S held by the holding part 72 and, when the sheet S is folded, the rollers 19 holding the sheet S and conveying the sheet S can be retreated from the conveying path 20 by the retreating part 39. Because the sheet S is released from the holding by the rollers 19, the folding piece can properly be approximated to the held piece. The folding piece can easily be approximated to the held piece by removing the rollers 19 from the move route of the folding piece to the held piece.

Because the approximating part 72 includes the rotating part 73 that rotates the folding piece toward the held piece centering the crease C formed on the sheet S as the rotation center, the folding piece can be rotated by the rotating part 73 toward the held piece positioned at the holding part 71 of the conveying path 20, and the sheet S can easily be folded.

Because the folding device 7 folds the sheet S along the longitudinal crease Cf along the conveyance direction of the conveying device 2 or the transverse crease Cw along the width direction W perpendicular to the conveyance direction F, that is disposed on the sheet S, the sheet S can easily be folded along the longitudinal crease Cf or the transverse crease Cw.

Because the retreating part 39 includes the moving part 30 that moves the axis 37 rotatably supporting the rollers 19, toward the outside of the conveying path 20, the moving part 30 can be caused to easily move the rollers 19 to the outside of the conveying path 20.

Because the moving part 30 swings the axis 37 with the swinging shaft 38 as the pivoting center, the rollers 19 can easily be moved from the conveying path 20 keeping the rollers 19 supported by the axis 37.

Because the swinging shaft 38 extends along the conveyance direction F, the rollers 19 can be moved into the direction to space from the conveying path 20 by swinging the axis 37 with the swinging shaft 38 as the pivoting center.

Because the retreating part 39 moves the rollers 19 from the conveyance position at which the rotating shafts 34 of the rollers 19 are along the width direction W perpendicular to the conveyance direction F of the conveying device 2 to the retreat position at which the rotating shafts 34 are in the direction that intersects with the width direction W, the rollers 19 extending in the width direction W at the conveyance position can easily be moved to the retreat position when the folding piece is approximated to the held piece keeping the held piece held by the holding part 71.

Because the rotating shaft 34 is along the up-down direction at the retreat position, the folding piece held by the rollers 19 therebetween and conveyed thereby can easily be opened. The rollers 19 can be caused to extend along the up-down direction and, in the case where the folding piece takes a move route that passes above the conveying path 20 when the folding piece approximates to the held piece, the rollers 19 can easily be retreated to the outside of the move route, by causing the rotating shafts 34 of the rollers 19 to be along the up-down direction.

### Second Embodiment

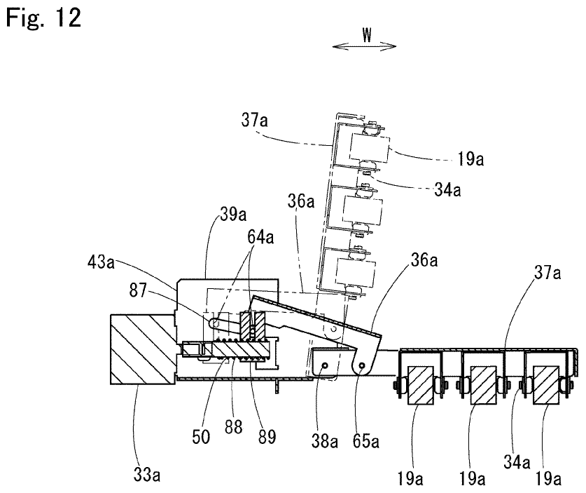

FIG. 12 shows a longitudinal cross-sectional view of a retreating part 39a according to a second embodiment of the present invention. The retreating part 39 includes the rotating body 35 in the above first embodiment. Instead of this, the retreating part 39a includes a screw part 50 in this second embodiment. The screw part 50 includes a male screw part 88 and a female screw part 89. The male screw part 88 is rotated by driving of a driving part 33a. The female screw part 89 is screwed with the male screw part 88. The female screw part 89 moves along the width direction W being guided by an elongated slot 87 disposed in a support bed 43a by the rotation of the male screw part 88. The female screw part 89 is coupled with an end of a link 36a by a pin 64a.

When the rollers 19a are moved to the retreat position by the retreating part 39a according to the second embodiment, a controller 9a drives the driving part 33a. The male screw part 88 is rotated by the driving of the driving part 33a to move the female screw part 89 leftward in FIG. 12. The link 36a is moved leftward and rollers 19a are swung with a swinging shaft 38a as the pivoting center. Rotating shafts 34a of the rollers 19a that are along the width direction W each in a horizontal attitude at a conveyance position of the sheet S become along the up-down direction at a retreat position as shown by a dashed-two dotted line.

Because the retreating part 39a includes the screw part 50 in this second embodiment, the move amount from the conveyance position to the retreat position of the rollers 19a can precisely be controlled for the position, from the driving amount of the driving part 33a. The gear ratio can be set to be great when the female screw part 89 is moved in the width direction W to retreat the rollers 19a, and the screw part 89 can be moved with a small driving force. A small and inexpensive motor can therefore be used leading to cost reduction.

The present invention is however not limited to the first and the second embodiments described above. The approximating part 72 includes the rotating part that rotates the folding piece toward the held piece centering the crease C formed on the sheet S as the rotation center in the above embodiments while, instead of this, the folding piece may be approximated to the held piece centering another point other than the crease as the rotation center, and the folding piece may be folded not by the rotational move but by moving in parallel to the held piece by a necessary amount.

The folding device 7 folds the sheet along the longitudinal crease along the conveyance direction of the conveying device 2 or the transverse crease along the width direction perpendicular to the conveyance direction that is disposed on the sheet S while the crease may be oblique to the conveyance direction. The retreating part 39 includes the moving part 30 that moves the axis 37 rotatably supporting the rollers 19, toward the outside of the conveying path 20 while the rollers themselves may be moved or the rollers may be retreated to a position that is located above or under the conveying path 20 and at which the rollers do not obstruct the folding operation.

The moving part 30 includes the swinging part 40 that swings the axis 37 with the swinging shaft 38 as the pivoting center while the axis 37 may be moved in the up-down direction, may be ascended or descended, may be translated, or may be obliquely moved. The swinging shaft 38 extends in the conveyance direction F while the swinging 38 may be formed obliquely to the conveyance direction F by three-dimensionally moving the axis 37 forward or backward relative to the conveying direction. The retreating part 39 moves the rollers 19 from the conveyance position at which the rotating shafts 34 of the rollers 19 are along the width direction W perpendicular to the conveyance direction F of the conveying device 2, to the retreat position at which the rotating shafts 34 are in the direction intersecting with the width direction W while the rollers may be moved to a retreat position at which the rotating shafts 34 are parallel to the conveyance direction.

The case where the rotating shafts 34 are along the up-down direction at the retreat position has been described while the rollers may be retreated to the outside of the conveying path for the rotating shafts of the rollers to be along the conveyance direction at the retreat position. The case where the rollers 281 to 287 capable of being retreated by the retreating part 39 are each divided into three pieces in the width direction has been described while the rollers 281 to 287 may each be divided into two pieces or four or more pieces, or may not each be divided. The case where the length of each of the rollers 281 to 287 in the width direction W is about a half of the length of the conveying path 20 in the width direction W has been described while the length of each of the rollers 281 to 287 may be shorter than a half thereof, may be longer than this, or may be longer than the length of the conveying path.

The retreating part 39 is disposed only on the one side of the conveying path 20 while, in the case where the rollers are each divided in the width direction and the divided pieces are each individually supported, the retreating part may be disposed on each of both of the right and the left sides of the conveying path and the rollers may be retreated on both of the right and the left sides of the conveying path.

The folding apparatus 1 includes the first and the second paste applying devices 81 and 82 while no paste applying device may be disposed and three or more paste applying devices may be disposed. The front folding piece H and the rear folding piece I are respectively folded along the front longitudinal crease C3 and the rear longitudinal crease C4 without conveyance, keeping the position at which the paste is applied to each of the front paste margin D and the rear paste margin E by the first and the second paste applying devices 81 and 82 while, in the case where the paste applying devices and the folding device are disposed at positions distant from each other, the sheet may be conveyed until the crease of the sheet after applying the paste thereto arrives at a predetermined folding device and, at the time point at which the crease arrives at a proper folding device, the conveyance of the sheet may be stopped and a folding process may be executed.

The folding apparatus 1 includes the longitudinal crease device 5 and the transverse crease device 6 that each form a crease while, in the case where a folding process is applied to a sheet already having the creases formed thereon, no mechanism to form any crease may be disposed. The folding apparatus 1 includes the first to the fourth folding devices 11 to 14 while the folding apparatus 1 only has to include at least one folding device, and may include two or three folding devices, or may include five or more folding devices.

The shape of the sheet to which the folding process is applied by the folding apparatus 1 is not limited to the one shown in FIG. 8, and the sheet only has to be a sheet capable of being folded along a crease and may be a sheet to form a box to hold name cards, a sheet to form a container to hold a bottle, a container, a Western liquor, or the like, or a sheet to form each of various types of folded paper sheet such as a Christmas card, a membership card, or a coupon ticket.

The various types of processing information are manually set from the operational panel by the user while the various types of processing information may automatically be input by reading a bar code, a two-dimensional code, or the like using a reading part, or may be set by executing communication with an external information processing device such as a personal computer. Plural folding patterns for a sheet may be stored in a storing means in advance by manual inputting from the operational panel and each of the patterns may be invoked using a number or the like to be set.

The rollers 281 to 287 adjacent to the folding device 7 that executes the folding, on the upstream side thereof and the downstream side thereof are retreated by the retreating part 39 while all the rollers 281 to 287 may be moved at one time to the retreat position.

### EXPLANATIONS OF LETTERS OR NUMBERS

C crease, Cf longitudinal crease, Cw transverse crease, S sheet, F conveyance direction, W width direction, 1 folding apparatus, 2 conveying device, 7 folding device, 9 controller, 19, 281 to 287 roller, 20 conveying path, 34 rotating shaft, 37 axis, 38 swinging shaft, 39 retreating part, 40 swinging part, 71 holding part, 72 approximating part, 73 rotating part

1. A folding apparatus comprising:
a conveying device including a roller that holds and conveys a sheet; and
a folding device that folds the sheet conveyed by the conveying device, wherein
the folding device includes:
a holding part that holds the sheet on a conveying path; and
an approximating part that approximates a folding piece of the sheet to a position opposite a held piece of the sheet held by the holding part, and
the conveying device includes a retreating part that retreats the roller from the conveying path when the sheet is folded by the folding device.

2. The folding apparatus according to claim 1, wherein the approximating part includes a rotating part that rotates the folding piece toward the held piece centering a crease formed on the sheet as a rotation center.

3. The folding apparatus according to claim 1, wherein the sheet has a longitudinal crease along a conveyance direction of the conveying device and a transverse crease along a width direction perpendicular to the conveyance direction, and the folding device folds the sheet at the longitudinal crease or at the transverse crease.

4. The folding apparatus according to claim 1, wherein the retreating part includes a moving part that moves an axis rotatably supporting the roller toward an outside of the conveying path.

5. The folding apparatus according to claim 4, wherein the moving part includes a swinging part that swings the axis with a swinging shaft as a pivoting center.

6. The folding apparatus according to claim 5, wherein the swinging shaft extends along the conveyance direction.

7. The folding apparatus according to claim 1, wherein the retreating part moves the rollers from a conveyance position at which a rotating shaft of the roller is along the width direction perpendicular to the conveyance direction of the conveying device to a retreat position at which the rotating shaft is in a direction that intersects with the width direction.

8. The folding apparatus according to claim 7, wherein the rotating shaft is along an up-down direction at the retreat position.
